(19) United States
(12) Patent Application Publication
(10) Pub. No.: US 2004/0078656 A1
(43) Pub. Date: Apr. 22, 2004

(54) Method of saving/restoring processor state after entering/exiting debug mode

(76) Inventor: Mike Ryken, San Jose, CA (US)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,253

(22) Filed: Jun. 26, 2002

(51) Int. Cl. G06F 11/00; G06F 9/44

(52) U.S. Cl. 714/15; 712/228; 712/227

(57) ABSTRACT

A method of saving/restoring a processor state after entering/exiting a debug mode. When a processor desires to perform a debugging process, the processor enters a debug mode. A resume instruction is produced. The program counter of the resume instruction is stored into a register. The debugging instructions are performed without need to count the number of the instructions having been executed during the debug mode. When the processor wants to exit the debug mode, then the processor fetches the program counter stored in the register, and jumps back to the resume instruction.

### BACKGROUND OF INVENTION

1. Field of Invention

The present invention relates to a debug technology in a computer system. More particularly, the present invention relates to a method of saving/restoring a processor state after entering/exiting a debug mode.

2. Description of Related Art

Computer system nowadays is very common for processing data. In order to facilitate the development of new data processing hardware and software, it is known to provide dedicated debug mechanisms. Such debug mechanisms typically allow diagnostic data to be recovered and debug instructions to be executed, such as instructions to recover certain data values to locations from which they can be accessed as diagnostic data. In addition, it may be desired to execute specific instructions that use particular features or portions of the system being debugged to test the operation of those particular features or portions.

Typically, when a debugger signals a processor to enter a debug mode, the processor operation is halted. The first instruction that is not executed due to the debug request is called the resume instruction.

While in the debug mode, the debugger can read write and write registers and memory by inserting instruction into the core. Executing instructions in the debug mode causes the program counter (PC) to change. Upon exiting from the debug mode, the debugger must execute a branch instruction that will cause the processor to fetch the resume instruction. As a result, this allows the processor to resume operation as though uninterrupted.

In the conventional debug method, the debugger must keep track of how many instructions have been executed during the debug mode. This number, plus some constant allowing for change during debugging entry, will be used to determined how far to branch from the current program counter. Following this branch, the processor will resume normal operation by fetching the resume instruction.

FIG. 1 is a process diagram, schematically illustration the debug action with respect to the address of the PC. In FIG. 1, a PC is shown by starting from a PC at i, where the resume instruction is stored. In the step 10, the system enters the debug mode. In the step 12, the resume instruction is stored at PC i. In the step 14, a constant N is set for branching. At this moment, the PC jumps to i+N. In the step 16, the debugging instructions are executed. For example, M instructions have been executed during the debug mode. In the conventional debug method, the constant N and the quantity of M is very important. If an counting error occurs, the system then will failed to return to the resume instruction. In the step 18, when the debugger finishes the debugging instructions and intends to return back to the normal mode, the resume instruction is obtained by subtracting the quantity of N+M from the current PC.

As a result, the conventional debug method for the processor in the computer system is very depending on the branching constant N and the number of the instructions M actually being executed, so as to correctly return back to the resume instruction. In other words, if the counting of the debug instruction has an error, the system will failed to return to the original state. The counting process then will become tedious and could cause an error.

### SUMMARY OF INVENTION

The invention provides a method of saving/restoring a processor state after a processor entering/exiting a debug mode, so that the address of the resume instruction can be independently saved without affection from the branching point and the actual number of steps being executed in the debug mode. When the debugging system exits the debug mode, the address of the resume instruction is simply fetched and and then start the normal operation.

The invention also provides a resume register suitable for used in a debugging system, so as to store the resume address of the resume instruction. The resume address can be fetched from the resume register when the debugging system exits the debug mode.

As embodied and broadly described herein, the invention provides a method of saving/restoring a processor state after entering/exiting a debug mode. When a processor desires to perform a debugging process, the processor enters a debug mode. A resume instruction is produced. The program counter of the resume instruction is stored into a register. The debugging instructions are performed without need to count the number of the instructions having been executed during the debug mode. When the processor wants to exit the debug mode, then the processor fetches the program counter stored in the register, and jumps back to the resume instruction.

In the foregoing method, the data storage space is provided by a register.

The present invention also provides a resume register, suitable for use in a debugging system for storing a resume address of a resume instruction in a debug mode. The resume register comprises a first multiplexer, receiving a program counter (PC), a debugging data, and a control signal for entering the debug mode, wherein the multiplexer also receives a force-resume signal to select the debugging data or the PC. An OR logic gate receives the control signal for entering the debug mode and the force-resume signal, and exporting an output signal. A first flip-flop receives the output signal of the OR logic gate and an output data from the first multiplexer, and exporting the resume address under control by the output signal of the OR logic gate. A second multiplexer receives the PC and the resume address from the first flip-flop, and a control signal for exiting the debug mode; and a second flip-flop, receiving an output data of the second multiplexer and exporting the PC.

In the forgoing resume register, when the control signal for entering the debug mode is set by the debugging system to the first multiplexer, the first flip-flop saves the current PC as the resume address with respect to the resume instruction.

When the control signal for exiting the debug mode is set by the debugging system to the second multiplexer, the second flip-flop loads the resume address and exports the resume address as the PC with respect to the resume instruction.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a process diagram, schematically illustration the conventional debug action with respect to the address of the PC;

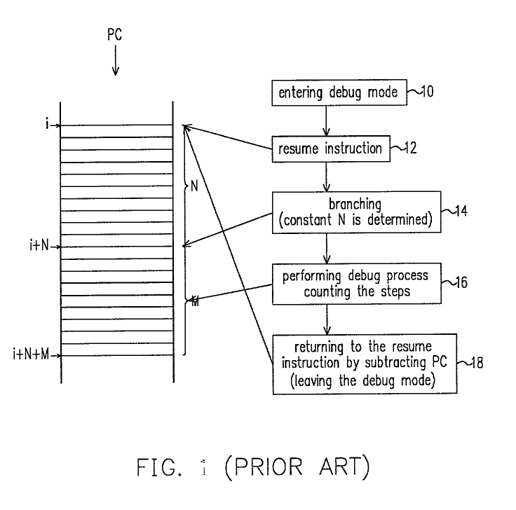

FIG. 2 is a process diagram, schematically illustration the debug action with respect to the address of the PC, according to one preferred embodiment of this invention; and

FIG. 3 is a block diagram, schematically illustrating a circuit structure of resume register for storing a resume address, according to one preferred embodiment of the invention.

### DETAILED DESCRIPTION

The invention introduces a method for independently storing a resume address for a resume instruction when the processor enters a debug mode and fetching the resume address after exiting the debug mode. In this manner, since the resume address is stored separately, the resume address is not affected by any change of the program counter during executing the debugging instruction. This allows the debugging process to be performed in more convenient way and also without causing an error. Examples are provided only for general descriptions of features of the invention as follows.

First, as known by the skilled artisans, when a debugger signals a processor to enter a debug mode, the normal processor operation is halted. The first instruction that is not executed due to the debug request is called the resume instruction, which has a resume address with respect to a quantity of a program counter (PC).

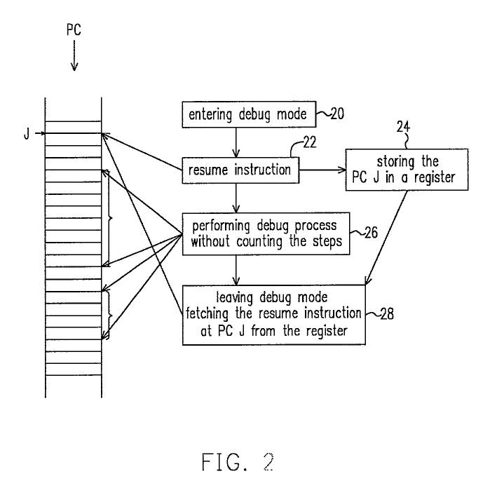

FIG. 2 is a process diagram, schematically illustration the debug action with respect to the address of the PC, according to one preferred embodiment of this invention. In FIG. 2, in the step 20, the processor intends to enter a debug mode, then a debugging system is in use for performing the debugging process. The debugging system can be, for example, a debugger to associate with the processor.

In the step 22, after entering the debug mode, the resume instruction is set. The resume instruction is, for example, located at the resume address at j of the PC. At the same time, the resume address is stored in a register as shown in the step 24. In the step 26, then the debug process is performed without counting the change of the PC due to the debugging instruction. The debug process may cause the change of the PC. However, any change of the PC does not affect the resume address J of the resume instruction during the debug mode. In the step 28, when the processor exits the debug mode, the resume address j of the resume instruction stored in the register is fetched. As a result, the processor returns back to the PC J, which corresponds to the resume instruction. Then, the processor returns back to the normal mode.

As shown in FIG. 2, the method of the invention is different from the conventional method by separately storing the resume address of the resume instruction when the processor enters the debug mode. After the processor exits the debug mode, the resume address is also separately fetched. The debugging instruction does not affect the resume address. In this manner, it is not necessary like the convention method to counting the change of the PC due to the debugging instruction. This can avoid the tedious counting of the PC, and an error due to missing counting can also be avoided.

The debugging method of the invention can also be used by a debugger, which associates with the processor. Then the register can be located in the debugger. Basically, the register is used to store the resume address. Therefore the register can be generally be replaced by a data storage space, which can be provided by any data storage device. The resume address may even be force to be stored in a new instruction address. All of these arrangements are not beyond the scope of the invention. The invention particularly introduces the manner to separately store the resume address when entering the debug mode. The actual way to store the resume address may have various options.

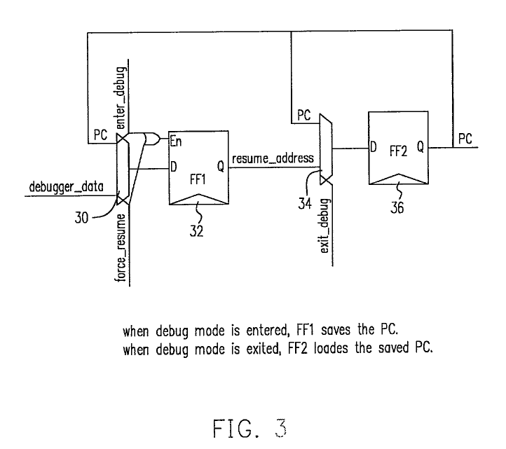

When the foregoing debug method of the invention is performed, a resume register is used to store the resume address. Based on the needed function in the method of FIG. 2, the resume register is described in FIG. 3, which is a block diagram, schematically illustrating a circuit structure of resume register for storing a resume address, according to one preferred embodiment of the invention. The resume register can be used in the debugging system associating with a processor (not shown).

The resume register includes, for example, a first multiplexer 30, a first flip-flop 32, a second multiplexer 34, a second flip-flop 36, and an OR logic gate. The first multiplexer 30 can receive the current PC in feedback and a debugger data. The first multiplexer 30 also receives a control signal for entering the debug mode. The control signal for entering the debug mode is set by the debugging system or a debugger. The first multiplexer 30 also receives a force resume signal to select the PC or the debugger data to be exported. The debugger data is a new instruction address, which under selection can be used to assign a new instruction address to the resume instruction. The actual operational mechanism is to be further described later.

The control signal for entering the debug mode and the force resume signal are input to the OR logic gate. The output data of the first multiplexer 30 is send to the first flip-flop 32. The flip-flop is also enabled by the logic output from the OR logic gate. When the system enters the debug mode, the PC or the new instruction address is saved in the first flip-flop 32 and is exported at a time under controlled based on the various types of the flip-flop. The output of the first flip-flop is a resume address.

The second multiplexer 34 receives the resume address and the PC in feed back. The second multiplexer 34 also receives a control signal for exiting the debug mode, which is set by the debugging system or the processor when the processor intends to leave the debug mode. For example, the processor has detected an end of the debug mode. While it is sill in the debug mode, the PC is selected as the output. However, when the debug mode is exited, the second multiplexer 34 then exports the resume address.

The second flip-flop 36 receives the output from the second multiplexer 34. As previously mention, during the debug mode, the PC is received from the second multiplexer 34. The PC can be changes as needed in the debug mode. The resume address is not changed at all. The PC is operated as the debug mode wants. However, when the debug mode is exited, the control signal for exiting the debug mode at the second multiplexer 34 will select the resume address and loads the resume address into the second flip-flop. Then the PC returns back to the original address with respect to the resume instruction. The debugging instruction does not affect the resume address. The number of the debugging instruction is not necessary to be tracked. Here, debugging instruction usually includes multiple steps. However, it can be only one step or even a zero step, which means an exit is immediately made after entering the debug mode. All of this kind of variation is just an actual operation.

According to the function in FIG. 3, one can get the operation results. When the processor enters the debug mode, the first flip-flop 32 saved the PC, and when the processor exits the debug mode, the second flip-flop loads the PC saved in the first flip-flop 32. If a new instruction address is desired, the new instruction address can be input to the first multiplexer 30 through the debugger data. However, if this kind of function is ignored, then the first multiplexer 30 and the Or logic gate can be omitted. The PC can be directly input to the flip-flop 32. The control signal for entering the debug mode is input to the flip-flop 32 at the enable terminal. As a result the PC with respect to the resume instruction can also be temporarily saved in the flip-flop 32. When the control signal for exiting the debug mode is set, then the saved PC with respect to the resume instruction is loaded into the second flip-flop 36.

In summary of the invention, the debugging method uses a data storage space to store the resume address, such as the PC when the debug mode is entered. When the debug mode is exited, the resume address is fetched to return to the original PC. There is no need to counting the change of the PC with the branching point.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A method of saving/restoring a processor state after a processor entering/exiting a debug mode, the method comprising:
storing an address of a resume instruction into the data storage space, when the processor intends to enter the debug mode;
performing a debugging instruction during the debug mode without need an actual track on the number of program counter (PC) for the debugging instruction being executed in the debug mode; and
fetching the address of the resume instruction from the data storage space, when the processor intends to exit the debug mode.

2. The method of claim 1, wherein the data storage space is provided by an data storage device.

3. The method of claim 1, wherein the data storage space is provided by a register.

4. The method of claim 1, wherein the data storage space is a new instruction address.

5. A debugging method for a debugger associating with a processor, the method comprising:
storing a program counter (PC) of a processor state with respect to a resume instruction into a data storing space in the debugger, when a debug mode is desired;
performing a debugging instruction by the debugger during the debug mode without need of an actual track on the number of PC for the debugging instruction being executed in the debug mode; and
fetching the PC of the resume instruction at the data storing space for the processor, when the debug mode is exited.

6. The method of claim 5, wherein the data storage space is provided by an data storage device.

7. The method of claim 5, wherein the data storage space is provided by a register.

8. The method of claim 5, wherein the data storage space is a new instruction address.

9. A resume register, suitable for use in a debugging system for storing a resume address of a resume instruction in a debug mode, the resume register comprising:
a first multiplexer, receiving a program counter (PC), a debugging data, and a control signal for entering the debug mode, wherein the multiplexer also receives a force-resume signal to select the debugging data or the PC;
an OR logic gate, receiving the control signal for entering the debug mode and the force-resume signal, and exporting an output signal;
a first flip-flop, receiving the output signal of the OR logic gate and an output data from the first multiplexer, and exporting the resume address under control by the output signal of the OR logic gate;
a second multiplexer, receiving the PC and the resume address from the first flip-flop, and a control signal for exiting the debug mode; and
a second flip-flop, receiving an output data of the second multiplexer and exporting the PC,
wherein when the control signal for entering the debug mode is set by the debugging system to the first multiplexer, the first flip-flop saves the current PC as the resume address with respect to the resume instruction,
wherein when the control signal for exiting the debug mode is set by the debugging system to the second multiplexer, the second flip-flop loads the resume address and exports the resume address as the PC with respect to the resume instruction.

10. The resume register of claim 9, wherein when the force-resume signal for the first multiplexer is set to assign a new instruction address for the resume address, the debugging data is selected for inputting the new instruction address while entering the debug mode.

11. A resume register, suitable for use in a debugging system for storing a resume address of a resume instruction in a debug mode, the resume register comprising:
a first flip-flop, receiving a program counter (PC) as the resume address, a control signal for entering a debug mode;
a multiplexer, receiving the PC and the resume address from the first flip-flop, and a control signal for exiting the debug mode; and
a second flip-flop, receiving an output data of the multiplexer and exporting the PC,
wherein when the control signal for entering the debug mode is set by the debugging system to the first flip-flop, the first flip-flop saves the current PC as the resume address with respect to the resume instruction, and when the control signal for exiting the debug mode is set by the debugging system to the multiplexer, the second flip-flop loads the resume address and exports the resume address as the PC with respect to the resume instruction.
